(19) United States
(12) Patent Application Publication
(10) Pub. No.: US 2025/0383250 A1
(43) Pub. Date: Dec. 18, 2025

(54) FORCE SENSOR

(71) Applicant: FANUC CORPORATION, Yamanashi (JP)

(72) Inventor: Yuusei ONODERA, Yamanashi (JP)

(73) Assignee: FANUC CORPORATION, Yamanashi (JP)

(21) Appl. No.: 18/878,197

(22) PCT Filed: Aug. 9, 2022
(86) PCT No.: PCT/JP2022/030472

§ 371 Date: Dec. 23, 2024

(51) Int. Cl. G01L 1/26; G01L 1/14; G01L 5/165

(52) U.S. Cl. CPC G01L 1/26; G01L 1/142; G01L 5/165

(57) ABSTRACT

A force sensor includes: a first substrate, a second substrate and a third substrate that are disposed so as to be spaced apart from each other in a plate-thickness direction; a first connection member connecting the first substrate to the second substrate so that the same are displaceable in the plate-thickness direction; a second connection member connecting the second substrate to the third substrate so that the same are displaceable in a direction perpendicular to the plate-thickness direction; a first detection unit configured to detect relative displacement between the first substrate and the second substrate; and a second detection unit disposed extending in the plate-thickness direction between the second substrate and the third substrate for detecting relative displacement between the second substrate and the third substrate. The second substrate includes a thick portion in a region other than a mounting region of the second detection unit.

### TECHNICAL FIELD

The present disclosure relates to a force sensor.

### BACKGROUND

Heretofore, displacement-detection-method force sensors have been known (see Japanese Patent No. 6673979, for example).

A force sensor includes three substrate portions disposed so as to be spaced apart from each other in a plate-thickness direction, detection units disposed between these substrate portions, and a force calculation unit that calculates a force component based on values detected by the detection units.

The force calculation unit consists of a processor mounted on a printed board and generates heat when the power is turned on. The substrate portions are formed to be thin in order to reduce the thickness of the force sensor, and therefore the substrate portions are easily affected by thermal changes. Therefore, the force sensor includes relaxation portions that absorb thermal deformation of the substrate portions through elastic deformation.

### SUMMARY

In an aspect of the present disclosure, a force sensor includes: a first substrate; a second substrate disposed so as to be spaced apart from the first substrate in a plate-thickness direction; a third substrate disposed so as to be spaced apart from the second substrate in the plate-thickness direction; a first connection member connecting the first substrate to the second substrate so that the first substrate and the second substrate are displaceable in the plate-thickness direction; a second connection member connecting the second substrate to the third substrate so that the second substrate and the third substrate are displaceable in a direction perpendicular to the plate-thickness direction; a first detection unit configured to detect relative displacement between the first substrate and the second substrate; and a second detection unit disposed so as to extend in the plate-thickness direction between the second substrate and the third substrate and configured to detect relative displacement between the second substrate and the third substrate. The second substrate includes a thick portion in a region other than a mounting region of the second detection unit, the thick portion protruding toward the third substrate.

### BRIEF DESCRIPTION OF DRAWINGS

FIG. 1 is a longitudinal cross-sectional view illustrating a force sensor according to a first Embodiment of the present disclosure.

FIG. 2 is a plan view for describing an electrode plate provided on a second substrate of the force sensor in FIG. 1.

FIG. 3 is a schematic perspective view for describing first detection electrodes provided between a first substrate and a second substrate of the force sensor in FIG. 1.

FIG. 4 is a longitudinal sectional view for describing second detection electrodes provided between the second substrate and a third substrate of the force sensor in FIG. 1.

FIG. 5 is a plan view for describing the second detection electrodes in FIG. 4.

FIG. 6 is a schematic diagram for describing electrode plates of the second detection electrodes in FIG. 4.

FIG. 7 is a plan view for describing a cable of the second detection electrodes in FIG. 4.

FIG. 8 is a plan view illustrating a modification of the second substrate of the force sensor in FIG. 1.

FIG. 9 is a schematic longitudinal cross-sectional view illustrating a modification of the force sensor in FIG. 1.

FIG. 10 is a schematic longitudinal cross-sectional view illustrating another modification of the force sensor in FIG. 1.

FIG. 11 is a longitudinal cross-sectional view illustrating a force sensor according to a second Embodiment of the present disclosure.

FIG. 12 is a longitudinal cross-sectional view for describing second detection electrodes provided between a second substrate and a third substrate of the force sensor in FIG. 11.

FIG. 13 is a plan view for describing routing of cables of the second detection electrodes of the force sensor in FIG. 11.

### DETAILED DESCRIPTION OF EMBODIMENTS

A force sensor 1 according to a first Embodiment of the present disclosure will be described below while referring to the drawings.

The force sensor 1 according to this embodiment is, for example, a six-axis force sensor disposed between a base B of a robot and an installation surface A such as a floor. The force sensor 1 detects forces along three orthogonal axes acting on the robot and moments around the three axes.

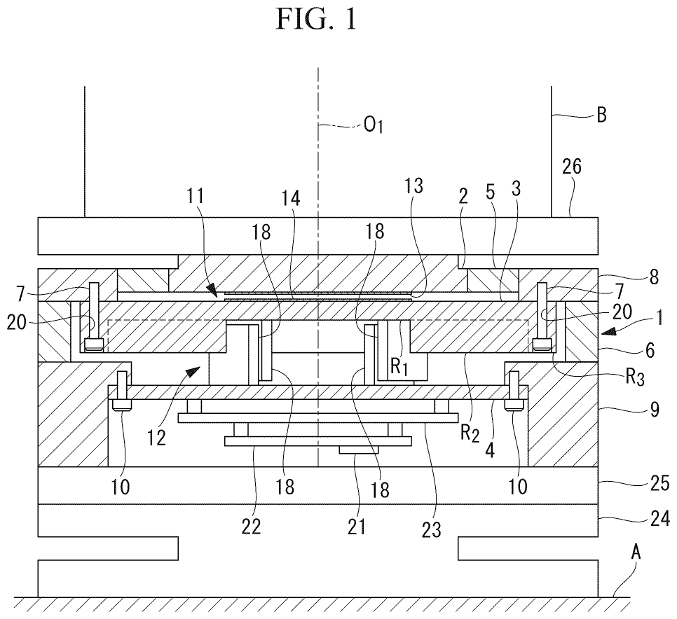

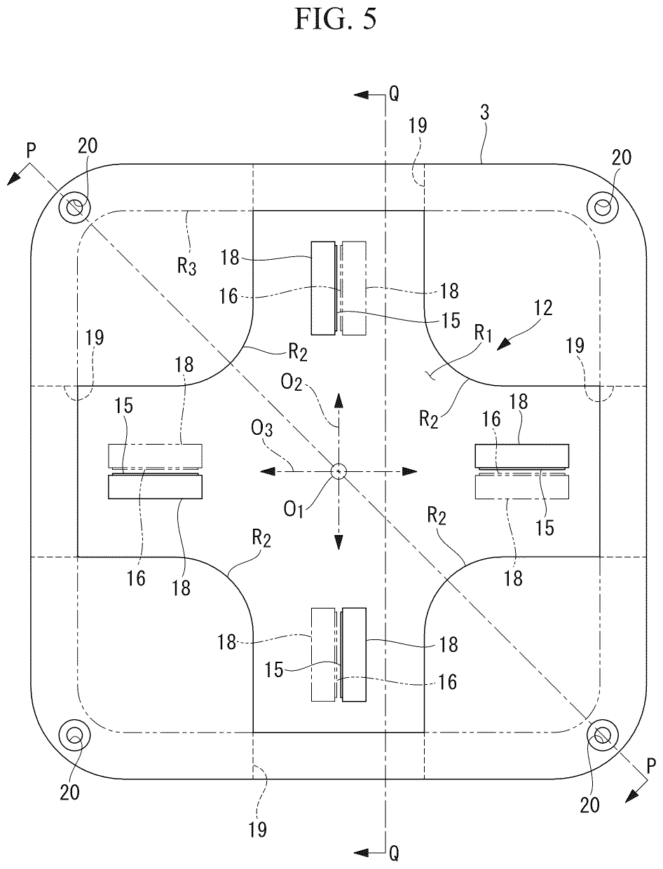

As illustrated in FIG. 1, the force sensor 1 includes a first substrate 2, a second substrate 3 disposed parallel to and spaced apart from the first substrate 2 in a plate-thickness direction, and a third substrate 4 disposed parallel to and spaced apart from the second substrate 3 in the plate-thickness direction. Hereafter, an axis line passing through the centers of the first substrate 2, the second substrate 3, and the third substrate 4 and extending in the plate-thickness direction is referred to as a first axis O₁, and the plate-thickness direction is also referred to as a direction of the first axis O₁. FIG. 1 illustrates a cross section taken along P-P in FIG. 5.

The force sensor 1 further includes a first connection member 5 that connects the first substrate 2 to the second substrate 3 so that the first substrate 2 and the second substrate 3 are displaceable in the direction of the first axis O₁, and a second connection member 6 that connects the second substrate 3 to the third substrate 4 so that the second substrate 3 and the third substrate 4 are displaceable in a direction perpendicular to the direction of the first axis O₁. Specifically, as illustrated in FIG. 1, the force sensor 1 includes a junction member 8 that fixes the second substrate 3 in place using, for example, bolts 7, and a frame-shaped base member 9 that fixes the third substrate 4 in place using, for example, bolts 10.

The first substrate 2 is connected to the second substrate 3 by the first connection member 5 via the junction member 8, for example. In addition, the second substrate 3 is connected to the base member 9 by the second connection member 6 via the junction member 8, for example. As a result, the first substrate 2 is indirectly connected to the second substrate 3 by the first connection member 5, and the second substrate 3 is indirectly connected to the third substrate 4 by the second connection member 6.

The first connection member 5 elastically deforms so that when an external force is received by the force sensor 1, the first substrate 2 and the second substrate 3 generate at least one of movement in the direction of the first axis O₁ or rotation around an axis line along a plane perpendicular to the direction of the first axis O₁ relative to each other. In other words, the first connection member 5 has low rigidity in the direction of the first axis O₁ and sufficiently high rigidity in a direction perpendicular to the first axis O₁.

When a force in the direction of the first axis O₁ or a moment around an axis line along a plane perpendicular to the direction of the first axis O₁ acts on the first substrate 2, the first connection member 5 elastically deforms and the distance between the first substrate 2 and second substrate 3 in the direction of the first axis O₁ changes. On the other hand, even if a force in a direction perpendicular to the first axis O₁ or a moment around the first axis O₁ acts on the first substrate 2, the first connection member 5 transmits the force or moment directly to the junction member 8 without elastically deforming.

When the force sensor 1 receives an external force, the second connection member 6 elastically deforms so that the second substrate 3 and the third substrate 4 generate at least one of movement in a direction perpendicular to the direction of the first axis O₁ or rotation around the first axis O₁ relative to each other. In other words, the second connection member 6 has low rigidity in a direction perpendicular to the first axis O₁ and has sufficiently high rigidity in the direction of the first axis O₁.

When a force in a direction perpendicular to the first axis O₁ or a moment around the first axis O₁ acts on the first substrate 2, the second connection member 6 elastically deforms and the second substrate 3 is displaced in a direction perpendicular to the first axis O₁ with respect to the third substrate 4. On the other hand, even if a force in the direction of the first axis O₁ or a moment around an axis line along a plane perpendicular to the first axis O₁ acts on the first substrate 2, the second connection member 6 does not elastically deform and does not cause relative displacement between the second substrate 3 and the third substrate 4.

The force sensor 1 further includes first detection electrodes (first detection units) 11 between the first substrate 2 and the second substrate 3. The first detection electrodes 11 detect relative displacement between the first substrate 2 and the second substrate 3. The force sensor 1 further includes a second detection electrodes (second detection units) 12 between the second substrate 3 and the third substrate 4. The second detection electrodes 12 detect relative displacement between the second substrate 3 and the third substrate 4.

The first detection electrodes 11 include a flat-plate-shaped electrode plate (first electrode plate) 13 fixed to a surface of the first substrate 2 facing the second substrate 3 and a flat-plate-shaped electrode plate (first electrode plate) 14 fixed to a surface of the second substrate 3 facing the first substrate 2. The electrode plates 13 and 14 consist of flexible printed circuits (FPCs), for example.

The electrode plates 13 and 14 are respectively directly fixed to surfaces of the first substrate 2 and the second substrate 3. Thus, the electrode plates 13 and 14 extend along planes perpendicular to the first axis O₁ and are disposed parallel to each other at positions facing each other with a small gap therebetween in the direction of the first axis O₁.

In the present disclosure, expressions such as “along” do not express only being strictly coincident or parallel with an object, such as an axis or a plane, but rather express a rough orientation. For example, “a direction along a certain axis or plane” encompasses directions that deviate from a direction strictly coinciding with or parallel to the direction represented by that axis or plane, for example, a direction intersecting that direction at an angle of less than 45°.

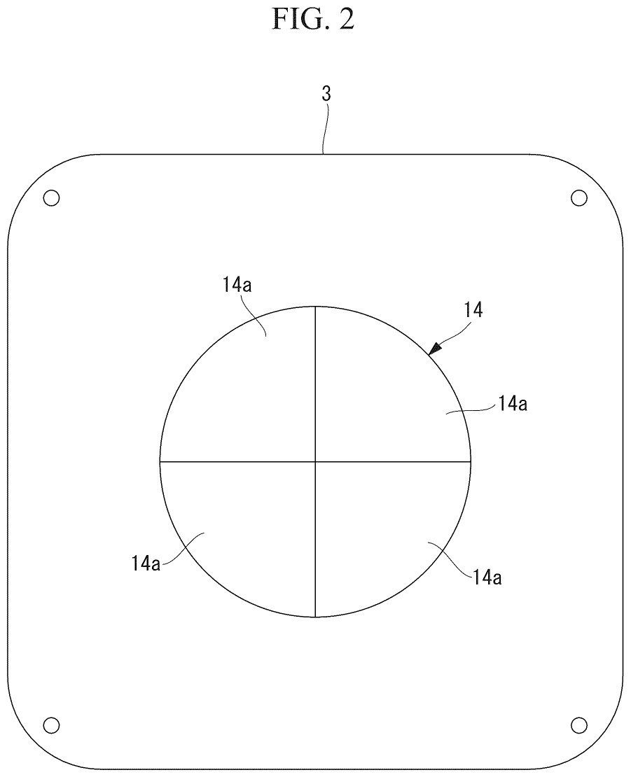

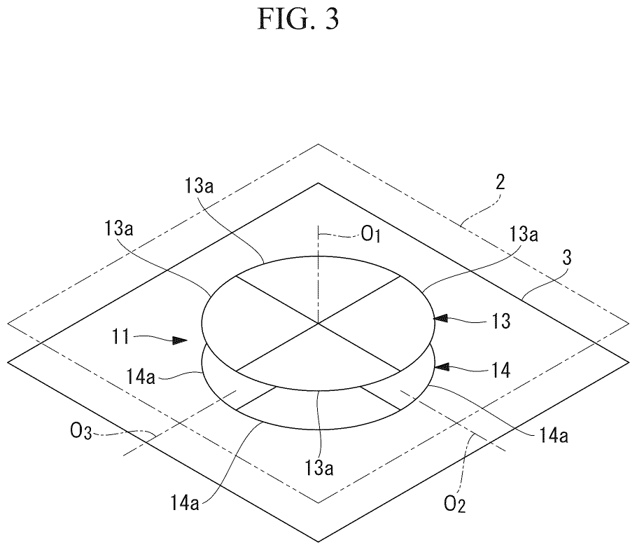

As illustrated in FIGS. 2 and 3, the electrode plates 13 and 14 respectively include a plurality of electrode pieces 13a and a plurality of electrode pieces 14a. Each electrode piece 13a or 14a is, for example, shaped like a fan with a central angle of 90°. The electrode plates 13 and 14 each have a circular shape when the four fan-shaped electrode pieces 13a or 14a are combined with each other.

The four fan-shaped electrode pieces 13a or 14a constituting each electrode plate 13 or 14 are disposed opposite each other, as illustrated in FIG. 3. This allows the four pairs of electrode pieces 13a and 14a to detect changes in capacitance values in response to changes in the gap between the electrode pieces 13a and 14a.

In other words, the first detection electrodes 11 can detect four capacitance values that change in accordance with the relative displacement of the first substrate 2 and the second substrate 3 in the direction of the first axis O₁. Then, a force component in the direction of the first axis O₁, a moment component around a second axis O₂ perpendicular to the first axis O₁, and a moment component around a third axis O₃ perpendicular to the first axis O₁ and the second axis O₂ can be calculated from the four acquired capacitance values.

When the first detection electrodes 11 are formed using multiple pairs of electrode pieces 13a and 14a, it is sufficient that the shapes of the electrode pieces 13a and 14a facing each other be the same. In other words, the shapes of the multiple electrode pieces 13a and 14a constituting the electrode plates 13 and 14 do not need to be the same as each other.

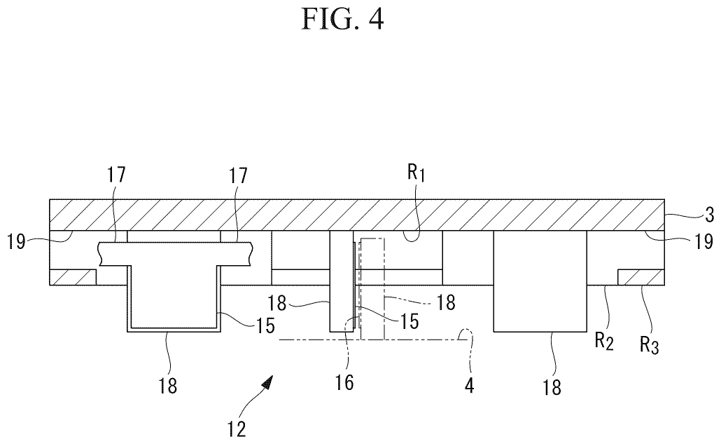

The second detection electrodes 12 include an electrode plate (second electrode plate) 15 fixed to a surface of the second substrate 3 facing the third substrate 4 and an electrode plate (second electrode plate) 16 fixed to a surface of the third substrate 4 facing the second substrate 3. As illustrated in FIG. 4, the electrode plates 15 and 16 are FPCs formed in a rectangular shape, for example, and are attached to surfaces of rectangular parallelepiped shaped members 18. Strip-shaped FPC cables 17 extend from the electrode plates 15 and 16. FIG. 4 illustrates a cross section taken along Q-Q in FIG. 5.

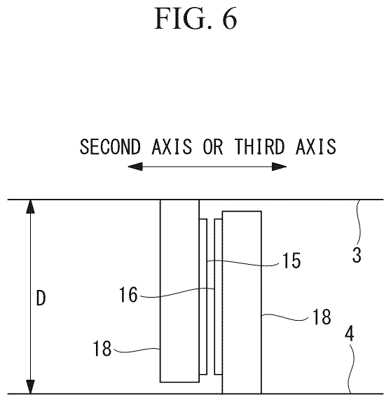

As illustrated in FIGS. 5 and 6, the electrode plates 15 and 16 are respectively fixed to surfaces of the second substrate 3 and the third substrate 4 by the rectangular parallelepiped shaped members 18. Thus, the electrode plates 15 and 16 each extend along the direction of the first axis O₁ and are disposed parallel to each other at positions facing each other with a small gap therebetween in a circumferential direction around the first axis O₁.

As described above, the electrode plates 15 and 16 are attached to the rectangular parallelepiped shaped members 18 of a prescribed size and extend along the direction of the first axis O₁. Therefore, as illustrated in FIG. 6, the second substrate 3 and third substrate 4 need to be disposed with a gap therebetween in the direction of the first axis O₁ equivalent to a distance D obtained by adding a small gap to the size of the rectangular parallelepiped shaped members 18 in the direction of the first axis O₁.

Multiple pairs of the electrode plates 15 and 16 are provided. For example, as illustrated in FIG. 5, four pairs of electrode plates 15 and 16, which face each other, are disposed in a cross-like shape with an equal circumferential spacing of 90° around the first axis O₁.

In other word, in two pairs of electrode plates 15 and 16 disposed on both sides of the first axis O₁ (for example, left and right in FIG. 5), the electrode plates 15 and 16 are disposed parallel to each other with a small gap therebetween in the direction of the second axis O₂ at positions facing each other. In addition, in each of the other two pairs of electrode plates 15 and 16 disposed on both sides of the first axis O₁ (for example, top and bottom in FIG. 5), the electrode plates 15 and 16 are disposed parallel to each other with a small gap therebetween in the direction of the third axis O₃ at positions facing each other.

Thus, the four pairs of electrode plates 15 and 16 of the second detection electrodes 12 can respectively detect changes in capacitance values in accordance with the gaps between the electrode plates 15 and 16. In other words, the second detection electrodes 12 can detect four capacitance values that change with the relative displacement of the second substrate 3 and the third substrate 4 in directions along a plane perpendicular to the first axis O₁. A force component in the direction of the second axis O₂, a force component in the direction of the third axis O₃, and a moment component around the first axis O₁ can then be calculated from the four acquired capacitance values.

In this embodiment, as illustrated in FIG. 5, the second substrate 3 is formed as a square flat plate with rounded corners, and the electrode plates 15 and 16 of the second detection electrodes 12 are mounted in a mounting region R1 at the center of the second substrate 3. The mounting region R1 is a substantially cross-shaped region that includes the mounting positions of the four pairs of electrode plates 15 and 16 disposed in a cross-like shape.

Middle portions (thick portion) R2 and an outer frame portion (thick portion) R3, which are regions other than the mounting region R1 surrounding the outside of the mounting region R1, are formed to be thicker than the mounting region R1. In this embodiment, the plate thickness dimensions of the middle portions R2 and the outer frame portion R3, which are bounded by the two-dot dash lines in FIG. 5, are the same as each other.

Specifically, the outer frame portion R3 is a frame-shaped region provided along the entire periphery of the second substrate 3, and the middle portions R2 are regions provided at the four corners of the second substrate 3 so as to be continuous with the inside of the outer frame portion R3.

More specifically, the second substrate 3 includes the thin-walled mounting region R1 formed by shaving away, in the plate-thickness direction, the central part of a flat metal plate having the thickness dimensions of the outer frame portion R3 and the middle portions R2.

The outer frame portion R3 provided along the periphery of the second substrate 3 is provided with through holes 19 that penetrate in radial directions around the first axis O₁ at the center of each side of the second substrate 3. The electrode plates 15 and 16 of the second detection electrodes 12 are disposed close to the inner side of the outer frame portion R3. The further away the electrode plates 15 and 16 are from the first axis O₁, the greater the detection sensitivity can be improved, and therefore the electrode plates 15 and 16 are disposed close to the outer frame portion R3.

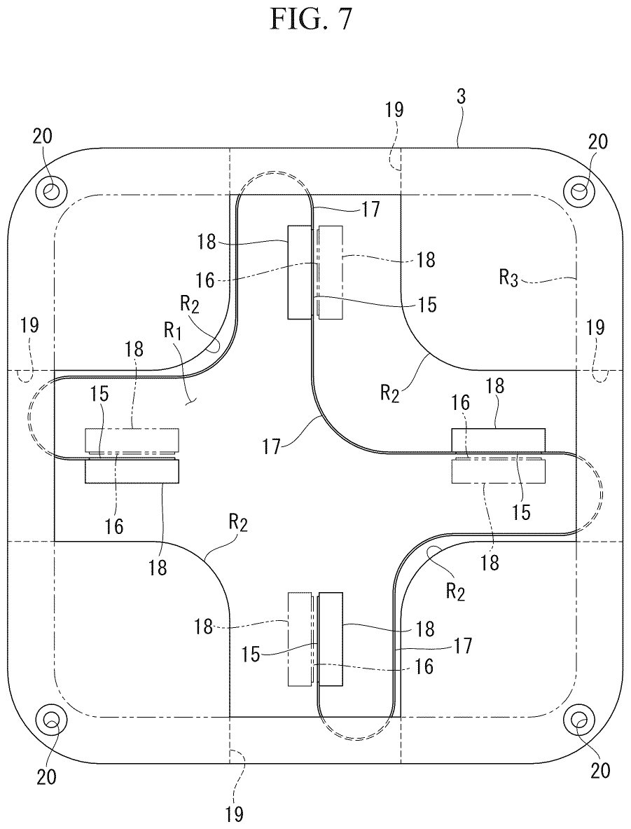

When the cables 17 connected to the electrode plates 15 and 16 are FPC cables, the cables 17 extend along the same plane as the electrode plates 15 and 16, in one direction or in both directions across each electrode plate 15 or 16. Therefore, the cable 17 extending from each electrode plate 15 or 16 toward the outer frame portion R3 would need to be forcibly bent with a small radius of curvature in the narrow gap with the outer frame portion R3 if there are no through holes 19 in the outer frame portion R3. According to this embodiment, providing the through holes 19 allows space to be secured in which the cables 17 led out toward the outer frame portion R3 can be curved without difficulty with a large radius of curvature, as illustrated in FIG. 7.

Instead of the through holes 19, cutouts can be used to secure space in which the cables 17 can be curved without difficulty as described above. In this embodiment, as a result of the through holes 19 being provided, the middle portions R2 on both sides of the through holes 19 can be connected to each other by the beam-shaped outer frame portion R3. In this way, the rigidity of the second substrate 3 can be effectively improved.

As illustrated in FIG. 7, through holes 20, which are for fixing the second substrate 3 to the junction member 8 using the bolts 7, are provided in the four corners of the outer frame portion R3 connected to the middle portions R2. By fixing the second substrate 3 to the junction member 8 in the outer frame portion R3, the rigidity of which has been increased by being made thicker, the second substrate 3 can be firmly supported by the junction member 8.

The force sensor 1 according to this embodiment further includes a processor 21 that calculates triaxial force components and triaxial moment components of an acting external force based on detected values detected by the first detection electrodes 11 and the second detection electrodes 12. As illustrated in FIG. 1, the processor 21 is mounted on a circuit board 22, and is fixed, for example, to the surface of the third substrate 4 on the opposite side from the second substrate 3. The processor 21 is a heat generating body that generates heat when energized.

A flat plate (heat-effect reducing member) 23 composed of a material having high thermal conductivity, such as an aluminum alloy, or a material with a high thermal insulation property, such as resin, is disposed between the third substrate 4 and the circuit board 22 so as to be spaced apart therefrom in the direction of the first axis O₁, for example. As illustrated in FIG. 1, the flat plate 23 is formed so as to be larger than the circuit board 22 and is disposed at a position so that the entire circuit board 22 is hidden when viewed from any position within the third substrate 4.

Although not illustrated, the electrode plates 13 and 14 of the first detection electrodes 11 are connected to the circuit board 22 by cables that pass through through holes that penetrate through the second substrate 3 and the third substrate 4 in the plate-thickness direction. In addition, the electrode plates 15 and 16 of the second detection electrodes 12 are connected to the circuit board 22 by cables that pass through through holes that penetrate through the third substrate 4 in the plate-thickness direction. The through holes in the third substrate 4 are also disposed at positions covered by the flat plate 23 (for example, in the vicinity of the center of the third substrate 4) in order to suppress transfer of heat from the processor 21 to the second substrate 3 via the through holes.

Operation of the thus-configured force sensor 1 according to this embodiment will be described below.

In order to detect external forces and moments acting on the robot using the force sensor 1 according to this embodiment, for example, the third substrate 4 is fixed in place on the installation side and the first substrate 2 is located on the side where external forces act.

In other words, the third substrate 4 is fixed to the installation surface A of the robot, e.g., the floor surface, either directly or indirectly (for example, via a sensor base 24 and an adapter 25), as illustrated in FIG. 1. The first substrate 2 is fixed to the bottom surface of the base B of the robot directly or indirectly (for example, through an adapter 26) as illustrated in FIG. 1.

When an external force acts on the robot, the external force acts on the first substrate 2 (via the adapter 26) and displaces the first substrate 2. The force sensor 1 detects either a force component or a moment component depending on the direction in which the first substrate 2 is displaced.

First, a case in which an external force acts on the second substrate 3 so as to pull the first substrate 2 away in the direction of the first axis O₁ will be described. In this case, the first connection member 5 is elastically deformed and the first substrate 2 is displaced in the direction of the first axis O₁ with respect to the second substrate 3. When the capacitance values between the four pairs of electrode pieces 13a and 14a of the first detection electrodes 11 change uniformly, the force component in the direction of the first axis O₁ is detected.

On the other hand, if the changes in the capacitance values between the four pairs of electrode pieces 13a and 14a of the first detection electrodes 11 are not uniform, a moment component around the second axis O₂ or the third axis O₃ is detected in addition to or instead of the force component in the direction of the first axis O₁.

In other words, when a difference occurs between the capacitances between the two pairs of electrode pieces 13a and 14a on both sides of the second axis O₂, a moment component around the second axis O₂ is detected. In addition, when a difference occurs between the capacitances between the two pairs of electrode pieces 13a and 14a on both sides of the third axis O₃, a moment component around the third axis O₃ is detected.

Next, a case in which an external force acts on the third substrate 4 so as to move the second substrate 3 in a direction perpendicular to the first axis O₁ will be described.

In this case, the first connection member 5 does not elastically deform and restrains relative movement between the first substrate 2 and the second substrate 3, whereas the second connection member 6 elastically deforms and the second substrate 3 is displaced in a direction perpendicular to the first axis O₁ with respect to the third substrate 4. When the capacitance values between the four pairs of electrode plates 15 and 16 of the second detection electrodes 12 change uniformly, the moment component around the first axis O₁ is detected.

On the other hand, if the changes in the capacitance values between the four pairs of electrode plates 15 and 16 of the second detection electrodes 12 are not uniform, at least one force component in the directions of the second axis O₂ or the third axis O₃ is detected. In other words, a force component in the direction of the second axis O₂ is detected when a difference occurs between the capacitance values between two pairs of electrode plates 15 and 16 spaced apart from each other in the direction of the second axis O₂. At this time, the changes in the capacitance values between the two pairs of electrode plates 15 and 16 spaced apart in the direction of the third axis O₃ are identical.

In addition, a force component in the direction of the third axis O₃ is detected when a difference occurs between the capacitance values between the two pairs of electrode plates 15 and 16 spaced apart from each other in the direction of the third axis O₃. At this time, the changes in the capacitance values between the two pairs of electrode plates 15 and 16 spaced apart from each other in the direction of the second axis O₂ are identical.

The capacitance values detected by the first detection electrodes 11 and the second detection electrodes 12 are sent to the processor 21 on the circuit board 22. The force and moment components acting on the robot are then calculated by the processor 21.

In this case, when power to the processor 21 is turned on, the processor 21 generates heat, and each component inside the force sensor 1 heats up. The processor 21, which is a heat source, is usually disposed on the circuit board 22 in an asymmetrical manner as illustrated in FIG. 1, and therefore the heat source is disposed unevenly with respect to the third substrate 4.

According to this embodiment, the flat plate 23 composed of a material with high thermal conductivity is disposed between the circuit board 22 and the third substrate 4. In this case, the heat from the processor 21 is transferred to the third substrate 4 and the second substrate 3 after being transformed (equalized) to a uniform distribution by the flat plate 23. Therefore, uneven heating of the third substrate 4 can be prevented even with rapid heating of the processor 21 immediately after the power is turned on.

If the third substrate 4 is heated unevenly, displacement of the third substrate 4 will vary from place to place, and this will result in differences in the capacitance values detected by the four pairs of second detection electrodes 12, and detection accuracy will be reduced. In this embodiment, detection accuracy can be improved by preventing uneven heating of the third substrate 4.

When the flat plate 23 composed of a material with a high thermal insulation property is disposed between the circuit board 22 and the third substrate 4, propagation of heat from the processor 21 is impeded by the flat plate 23. Therefore, rapid heating of the third substrate 4 and the second substrate 3 can be prevented even with rapid heating of the processor 21 immediately after the power is turned on.

The flat plate 23, which is composed of a material with high thermal conductivity or a high thermal insulation property, is formed to be larger than the circuit board 22 and is disposed at a position so that the entire circuit board 22 is hidden when viewed from any position within the third substrate 4. Thus, the transfer of radiant heat from the processor 21, which is a heat source, to the third substrate 4 can be impeded by the flat plate 23.

Furthermore, according to the force sensor 1 of this embodiment, the second substrate 3 is formed to be thicker than the mounting region R1 in the regions R2 and R3 outside the mounting region R1 of the electrode plates 15. This increases the rigidity of the second substrate 3 and significantly increases the thermal capacity of the second substrate 3 compared to the case where the entire second substrate 3 is a flat plate that is flat and has the same plate thickness dimension as the mounting region R1.

In the second substrate 3, the thick middle portions R2 and the outer frame portion R3 are integrated with the mounting region R1 in regions other than the cross-shaped mounting region R1, which is for mounting the second detection electrodes 12. Thus, even when the mounting region R1 is heated, heat from the mounting region R1 can quickly escape to the thick middle portions R2 and outer frame portion R3. As a result, thermal deformation of the mounting region R1 can be suppressed and detection accuracy can be improved.

In other words, even if the second substrate 3 is heated by the heat generated by the processor 21, an increase in temperature in the mounting region R1 can be suppressed and thermal deformation (particularly thermal deformation in the plate-thickness direction) can be reduced. In this case, according to this embodiment, in the second substrate 3, the middle portions R2 and the outer frame portion R3 protrude from the surface of the mounting region R1 toward the third substrate 4 so as to form the thick middle portions R2 and the thick outer frame portion R3.

The distance D is required between the second substrate 3 and the third substrate 4 to provide space in which to dispose the second detection electrodes 12 so as to extend along the direction of the first axis O₁. In this embodiment, the middle portions R2 and the outer frame portion R3 are formed to be thick by utilizing the space required between the second substrate 3 and the third substrate 4.

This allows the second substrate 3 to be made thicker and have a greater thermal capacity without increasing the distance D between the second substrate 3 and third substrate 4. In other words, there is an advantage that thermal deformation of the second substrate 3 can be suppressed and detection accuracy of capacitance values can be improved without increasing the overall height of the force sensor 1.

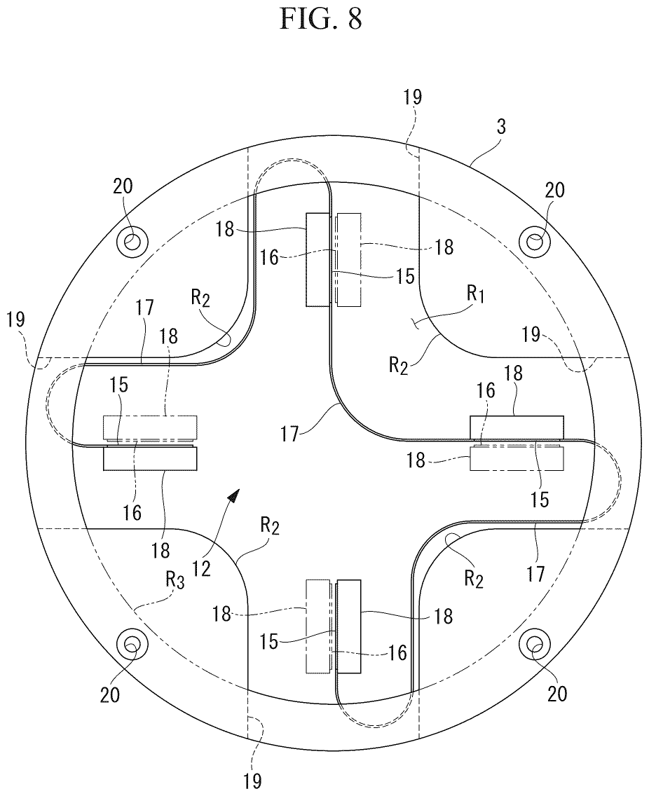

In the force sensor 1 according to this embodiment, a quadrangular-shaped substrate with rounded corners is exemplified as the second substrate 3, but the second substrate 3 is not limited to this configuration. The second substrate 3 may have a circular shape as illustrated in FIG. 8, or any other shape.

The force sensor 1 having the third substrate 4 side as the fixed side and the force acting on the first substrate 2 side has been exemplified, but the reverse configuration is also possible.

As illustrated in FIG. 1, the first substrate 2 is connected to the junction member 8, which is fixed to the second substrate 3, by the first connection member 5 and the third substrate 4 is connected to the junction member 8 by the second connection member 6, but this configuration does not have to be adopted.

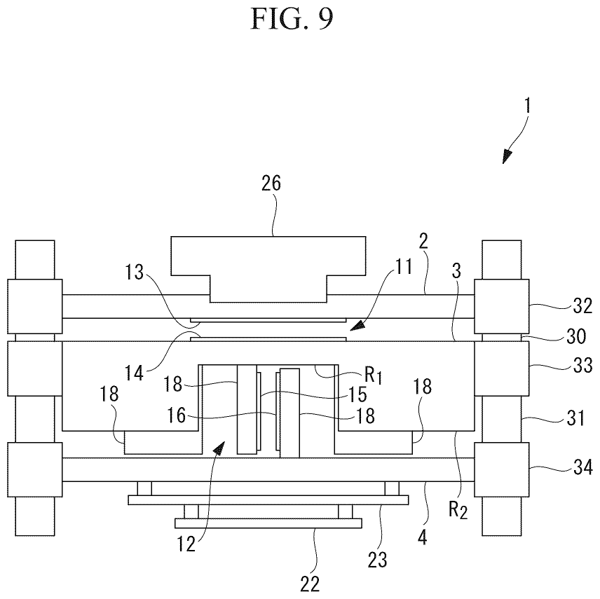

For example, as illustrated in FIG. 9, a configuration may be adopted in which parallel first to third substrates 2 to 4 are connected to three annular first to third bridge portions 32 to 34, which are connected to each other by first and second support column portions 30 and 31. For example, the first bridge portion 32 is an elastically deformable first connection member and the second support column portion 31 is an elastically deformable second connection member.

In this force sensor 1, the periphery of the second substrate 3 is configured to be thicker by being made to protrude toward the third substrate 4, thereby increasing the rigidity and heat capacity of the second substrate 3 while maintaining the overall height of the force sensor 1 as small. In the drawings, the first substrate 2 is fixed to the adapter 26, and external forces from the robot are transmitted through the adapter 26.

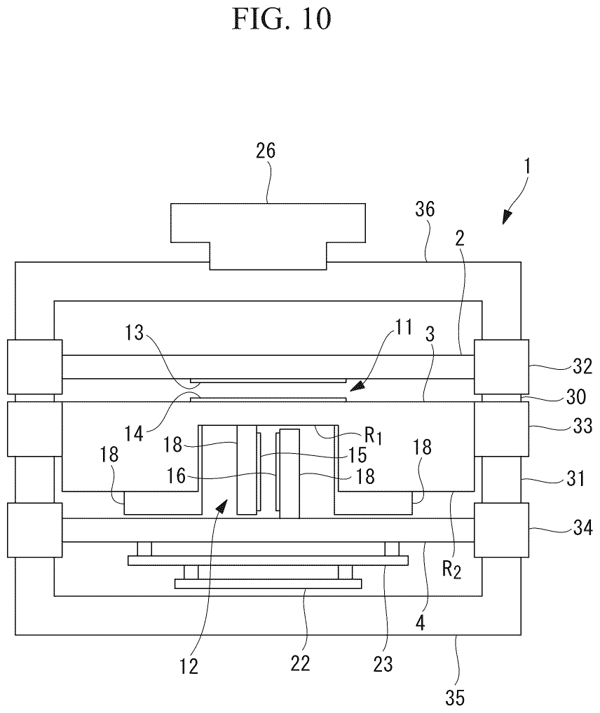

As illustrated in FIG. 10, an enclosure 35, which is connected to the third substrate 4 on the opposite side from the second support column portion 31 with the third bridge portion 34 therebetween, may be fixed in place as the installation side. An enclosure 36, which is connected to the first substrate 2 on the opposite side from the first support column portion 30 with the first bridge portion 32 therebetween, may be the side where forces act.

In this embodiment, the first detection unit 11 and the second detection unit 12 are configured as electrodes and detect capacitance values. Alternatively, the first detection unit 11 and the second detection unit 12 may detect changes in the amount of charge, inductance, light intensity, ultrasound, or magnetism, etc.

In addition, in this embodiment, an example has been exemplified in which the force sensor 1 is installed between the base B of the robot and the installation surface A such as a floor. Alternatively, the force sensor 1 of this embodiment may be applied to a case where the force sensor 1 is installed at another location in the robot, for example, between the end of a wrist and a tool.

Next, a force sensor 40 according to a second Embodiment of the present disclosure will be described below while referring to the drawings.

In the description of this embodiment, parts having the same configuration as in the force sensor 1 according to the first Embodiment described above are denoted by the same reference signs and description thereof is omitted.

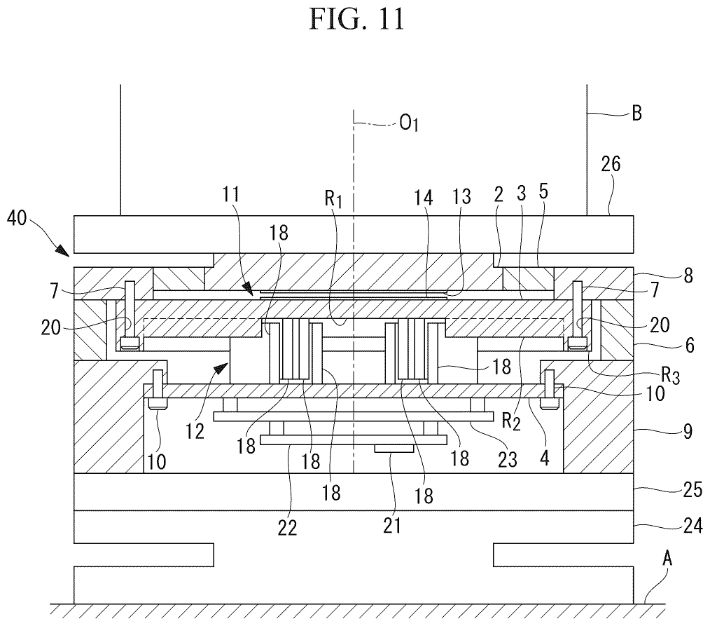

The force sensor 40 according to this embodiment includes two pairs of electrode plates 15 and 16 at each of four locations where the second detection electrodes 12 detect the same displacement, as illustrated in FIGS. 11 to 13.

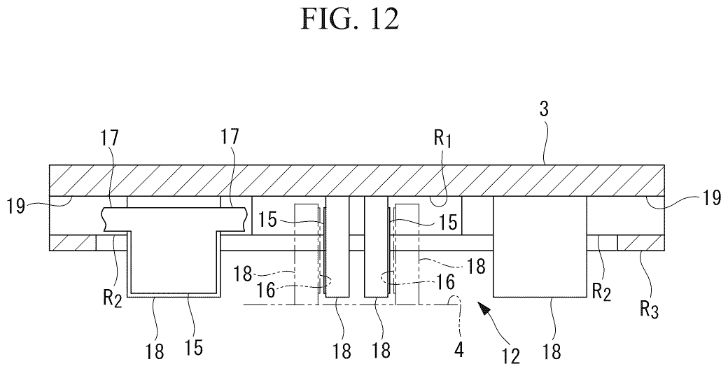

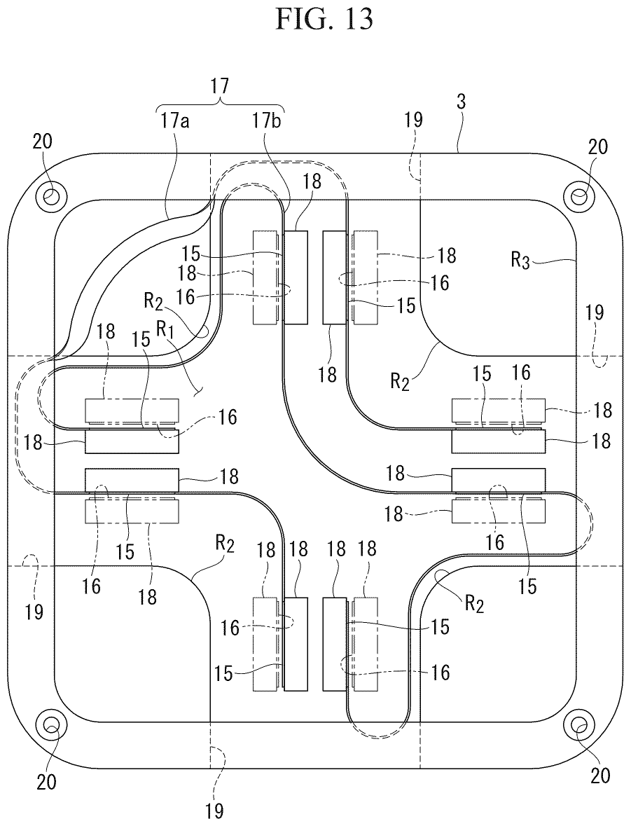

That is, the second detection electrodes 12 include two pairs of electrode plates 15 and 16 at each of four equally spaced locations in the circumferential direction around the first axis O₁, as illustrated in FIGS. 12 and 13. Thus, redundancy can be provided for the detection of forces and moments by the force sensor 40, and if some defect occurs in one of the two pairs of electrode plates 15 and 16, the detection accuracy can be maintained by the other pair.

In addition, in the force sensor 40 according to this embodiment, as illustrated in FIGS. 11 and 12, the plate thickness dimension of the middle portions R2 of the second substrate 3 is formed to be smaller than the plate thickness dimension of the outer frame portion R3. As a result, a step having a size equivalent to the difference in the plate thickness dimension is formed between the middle portions R2 and the outer frame portion R3. The step is formed to be larger than the thickness dimension of the cables 17.

By forming the middle portions R2 and the outer frame portion R3 of the second substrate 3 so as to be thick, the outer frame portion R3 and middle portions R2 are close to the surface of the opposing base member 9, as illustrated in FIG. 11. The gap in the direction of the first axis O₁ between the middle portions R2 and the base member 9 can be enlarged by providing a step between the outer frame portion R3 and the middle portions R2.

According to this embodiment, as illustrated in FIG. 13, the cables 17 can be routed by utilizing the gap enlarged by the step between the outer frame portion R3 and the middle portions R2. That is, when the cables 17 are FPC cables, the cables 17 can be twisted through 90° and made to follow the surfaces of the middle portions R2, as illustrated in FIG. 13.

Since two pairs of electrode plates 15 and 16 are disposed at one location, the number of cables 17 extending from each electrode plate 15 or 16 is increased compared to the force sensor 1 of the first Embodiment. In this case, if two cables 17 connecting the two pairs of circumferentially adjacent electrode plates 15 and 16 are routed along the same route, the two cables 17 may come into close proximity with each other or contact each other, and cause crosstalk and reduce detection accuracy.

According to this embodiment, as illustrated in the upper left part of FIG. 13, one cable 17a can be routed through positions crossing the middle portion R2. This has the advantage that the distance between the one cable 17a and another cable 17b is sufficient to prevent a decrease in detection accuracy.

In this embodiment, a case in which the electrode plates 13 and 14 and cables 17a and 17b are configured with FPCs has been exemplified, but this configuration does not have to be adopted. For example, the electrode plates 13 and 14 may be configured by metal plates or formed by deposition. Wires provided with an electrically insulating sheath may be used as the cables 17a and 17b.

Although embodiments of the present disclosure have been described in detail, the present disclosure is not limited to the individual embodiments described above. Various additions, substitutions, changes, partial omissions, and so forth may be made to the embodiments to the extent that the resulting embodiments do not depart from the gist of the present invention or from the idea and purpose of the present invention derived from the claims and equivalents thereto. For example, in the above-described embodiments, it is possible to change the order of operations, change the order of processes, omit or add some operations depending on conditions, or omit or add some processes depending on conditions, without being restricted to the above examples. The same also applies when numerical values or equations are used in the above description of the embodiments.

1. A force sensor comprising:
a first substrate;
a second substrate disposed so as to be spaced apart from the first substrate in a plate-thickness direction;
a third substrate disposed so as to be spaced apart from the second substrate in the plate-thickness direction;
a first connection member connecting the first substrate to the second substrate so that the first substrate and the second substrate are displaceable in the plate-thickness direction;
a second connection member connecting the second substrate to the third substrate so that the second substrate and the third substrate are displaceable in a direction perpendicular to the plate-thickness direction;
a first detection unit configured to detect relative displacement between the first substrate and the second substrate; and
a second detection unit disposed so as to extend in the plate-thickness direction between the second substrate and the third substrate and configured to detect relative displacement between the second substrate and the third substrate,
wherein the second substrate includes a thick portion in a region other than a mounting region of the second detection unit, the thick portion protruding toward the third substrate.

2. The force sensor according to claim 1,
wherein the first detection unit is configured to detect a value that varies with at least one of relative movement between the first substrate and the second substrate along a first axis, which is a central axis line extending in the plate-thickness direction, or relative rotation between the first substrate and the second substrate around a second axis perpendicular to the first axis and around a third axis perpendicular to the first axis and the second axis, and
the second detection unit is configured to detect a value that varies with at least one of relative movement between the second substrate and the third substrate along a plane perpendicular to the first axis, or relative rotation between the second substrate and the third substrate around the first axis.

3. The force sensor according to claim 1,
wherein the first detection unit includes flat-plate-shaped first electrode plates respectively fixed to opposing surfaces of the first substrate and the second substrate and extending in the direction perpendicular to the plate-thickness direction, and
the second detection unit includes flat-plate-shaped second electrode plates respectively fixed to opposing surfaces of the second substrate and the third substrate and extending in the plate-thickness direction.

4. The force sensor according to claim 3,
wherein four pairs of the second electrode plates are provided, and
the second electrode plates extend radially around the first axis and are disposed in a cross-like shape at different positions 90° from each other along a circumferential direction around the first axis.

5. The force sensor according to claim 4,
wherein the thick portion includes a middle portion interposed in the circumferential direction between adjacent ones of the second electrode plates in the circumferential direction.

6. The force sensor according to claim 5,
wherein the thick portion includes an outer frame portion provided along an entire periphery of the second substrate.

7. The force sensor according to claim 6,
wherein a plate thickness dimension of the middle portion is smaller than a plate thickness dimension of the outer frame portion.

8. The force sensor according to claim 7, further comprising:
a cable connecting the second substrates adjacent to each other in the circumferential direction,
wherein a step formed by a difference between the plate thickness dimensions of the outer frame portion and the middle portion is larger than a thickness dimension of the cable.

9. The force sensor according to claim 6,
wherein a through hole is provided in the outer frame portion adjacent to an outer side of each of the second electrode plates in a radial direction, and the through hole penetrates in the radial direction.

10. The force sensor according to claim 1, further comprising:
a processor configured to calculate a force or moment based on detected values detected by the first detection unit and the second detection unit,
wherein the processor is disposed on an opposite side of the third substrate from the second substrate, and
the force sensor further comprises a heat-effect reducing portion provided between the processor and third substrate and configured to reduce propagation of heat of the processor to the third substrate.
